(19) United States
(12) Patent Application Publication
(10) Pub. No.: US 2009/0272016 A1
(43) Pub. Date: Nov. 5, 2009

(54) Method and system of labeling user controls of a multi-function computer-controlled device

(76) Inventor: John Grigsby, Stateline, NV (US)

Correspondence Address: John Grigsby, 1566 Pacific Avenue, Alameda, CA, 94501, US

(21) Appl. No.: 12/311,171

(22) PCT Filed: Sep. 22, 2007
(86) PCT No.: PCT/US07/20458

§ 371 Date: Mar. 20, 2009

Related U.S. Application Data
(60) Provisional application No. 60/846,528, filed on Sep. 22, 2006.

(51) Int. Cl. G09F 3/00

(52) U.S. Cl. 40/299.01

(57) ABSTRACT

A method and system of labeling user controls of a multi-function computer-controlled device comprises a data storage medium with attached labeling and a user-accessible port by which the medium can be attached to the device, such that the data stored on the medium affects the actions performed by one or more of the user controls of the device, such that the attached labeling is physically visible to the user while operating the user controls of the device from a reasonable operating position, and such that this visible labeling comprises textual and/or graphical elements that describe the function of one or more of said user controls of said device, as enabled or determined partially or completely by the data. It is preferable, though not necessary to all embodiments, that the labeling be as close as is practical to the user controls, and that the layout of the labeling correspond as closely as is practical to the layout of the user controls.

### CROSS-REFERENCE TO RELATED APPLICATIONS

This application claims the benefit of PPA U.S. 60/846,528, filed 22 Sep. 2006 with the USPTO by the present inventor.

### FEDERALLY SPONSORED RESEARCH

Not Applicable.

### SEQUENCE LISTING

Not Applicable.

### BACKGROUND OF THE INVENTION

1. Field of the Invention

This invention relates to computer-controlled devices, specifically those with multiple functions, uses, or modes for a single set of user controls.

2. Discussion of Prior Art

Typically, a computer-controlled device will have one specific set of user-controllable functions. Its user controls will be labeled physically, usually with text or icons printed on the device itself or molded into the controls themselves. (Examples include television remote controls and answering machines.) This becomes increasingly problematic for user controls with two or three functions, as the labels become smaller and harder to read, and it becomes difficult or impossible as the number of functions grows larger. At that point, the user controls must be labeled generically, and the user is required to consult a manual or use trial and error to determine what action they perform.

Many common devices have user controls that perform too many different functions to label physically in a helpful way (e.g. ATMs, cellular telephones, videogame systems, rack-mount digital audio effects). Typically such devices contain some sort of text or graphic display, such as an LCD, VFD, or OLED, that can show the user what action will actually result if a control is used. The ATM, or “cash machine”, provides a classic example of this solution: its display screen is flanked by vertical columns of buttons whose function changes from menu to menu, and whose present function (if any) is shown by the display screen. In another example of such a solution, US 2001/0011953 (Shintani et. al) describes a remote controller with soft keys configurable using removable memory devices, specifically claiming a “display screen, for displaying control functions for the user interface.”

Displays, however, have disadvantages. They are expensive, they use power, they can be physically fragile, and they can be difficult to see from certain angles or in certain lighting conditions. A device with a display also requires hardware to drive the display, and extra computing power to maintain and update the display, all three of which add to the parts cost, power consumption, and difficulty of engineering. Furthermore, displays may not have sufficient resolution to show all the desired information at a reasonable cost (since their cost increases with resolution), or at all. For instance, a 20 character×2 line LCD, used to show the function of only four knobs, allows only two lines of four or five characters per knob.

Some video game systems, such as the Mattel Intellivision and Atari 5200, have attempted in the past to solve this problem without using a display, by providing separate “controller overlays”, which are pieces of plastic to be placed over the buttons on the controller when the associated game cartridge is inserted into the base unit. These “controller overlays” provide physical labels for the buttons on the controller, which are otherwise generically labeled or not labeled at all. However, controller overlays have obvious disadvantages. They require the user to perform multiple actions when switching games (removing and installing a new game cartridge, removing and installing a new controller overlay) instead of a single action, and the controller overlays are easily lost or separated from the game cartridge.

Milton Bradley's Microvision handheld game system incorporated some of the game controls (typically buttons), as well as their labels, into the game cartridges themselves. This allows great flexibility in control layout and labeling. Unfortunately, it also greatly increases the cost per cartridge. First, physical controls are expensive, and their inclusion means each cartridge costs much more to manufacture. Second, unlike typical game cartridges, which are all alike except for the contents of the mass storage chip and a sticker on the outside, each cartridge must be uniquely designed and manufactured, dramatically increasing design costs and reducing economies of scale in manufacturing.

The Line 6 “ToneCore” series of digital audio effect pedals (“stompboxes”) feature removable modules, each of which contains the effect program and data, plus all of the associated user controls (knobs, switches, buttons) and their labels, with the exception of the footswitch built into the unit. This has the advantage of ultimate flexibility, as each module can have its own special user controls, but it has the same disadvantage as the Microvision system—greatly increased design and manufacturing cost per module.

In short, it is obviously advantageous to solve this problem without resorting to adding a display and its associated hardware, which adds cost, complexity, physical fragility, and power consumption, and even then may have insufficient resolution to show all the desired information. However, I am unaware of any current solution that combines the simplicity, cost-effectiveness, obviousness, and physical robustness of physically labeled controls with the ability to change this labeling according to the current function of the device, while requiring no additional steps of its users and no separate overlays or other parts.

### BACKGROUND OF THE INVENTION

### Objects and Advantages

The objects and advantages of the first group of previous inventions as described above are to label user controls of a multi-functional computer-controlled device using a display screen, which can dynamically display the controls' current function.

The objects and advantages of the second group of previous inventions as described above are to label user controls of a multi-functional computer-controlled device, or to physically add custom user controls along with each different function or set of functions, without requiring a display screen and associated hardware.

The objects and advantages of the present invention over previous inventions using a display include the following: displays are expensive, they use power, they can be physically fragile, and they can be difficult to see from certain angles or in certain lighting conditions. A device with a display also requires hardware to drive the display, and extra computing power to maintain and update the display, all three of which add to the parts cost, power consumption, and difficulty of engineering. Furthermore, displays may not have sufficient resolution to show all the desired information at a reasonable cost (since their cost increases with resolution), or at all. For instance, a common 20 character×2 line LCD, used to show the function of only four knobs, allows only two lines of four or five characters per knob, making cryptic abbreviations necessary. In contrast, the limitation of printed labels in conveying information is generally human eyesight: printers can print smaller type than people can read.

The objects and advantages of the present invention over previous inventions that do not use a display are: to specifically label the user controls of a multi-functional computer-controlled device according to the current function of the device, without the associated disadvantages of the previous inventions, such as:

The user does not have to consult a manual or table, or use trial and error, in order to determine the function of a user control.

The user does not have to change a controller overlay, or other physical labeling object, in addition to changing the game cartridge or other storage medium.

The user cannot lose or otherwise separate a controller overlay, or other physical labeling object, from the game cartridge or other storage medium with which it is associated.

Since the present invention does not require user controls to be integrated into the game cartridge or other storage medium, design and manufacturing costs for the storage media can remain low.

### SUMMARY

The invention, a method and system of labeling user controls of a multi-function computer-controlled device, consists of a user-accessible port for attaching a removable data storage medium (such as a Compact Flash card, a USB key drive, a removable disk, or a proprietary cartridge comprising some form of solid-state memory) with attached labeling, such that the data stored on the medium affects the actions performed by one or more of the user controls of the device, such that the attached labeling is physically visible to the user while operating the user controls of the device from a reasonable operating position, and such that this visible labeling comprises textual and/or graphical elements that describe the function of one or more of said user controls of said device, as enabled or determined partially or completely by the data. It is preferable, though not necessary to all embodiments, that the labeling be as close as is practical to the user controls, and that the layout of the labeling correspond as closely as is practical to the layout of the user controls.

To use a device incorporating this invention, the user inserts or otherwise connects a removable data storage medium (such as a USB key drive) with attached labeling to the device. The device reads data from the storage medium that affects the function of some or all of the user controls. The user then looks at the visible portion of the medium (in this case, the top of the USB key drive) in order to determine the function of the user controls, and uses them to control the device. Should the user wish to change the function of the device, the user can remove the data storage medium with attached labeling and insert another.

### DRAWINGS

FIG. 1 is a ¾ view of a preferred embodiment, a digital audio processor in a form factor popularly known as a “stompbox”.

FIG. 2 is a view of the rear panel of the device in FIG. 1.

FIG. 3 is a view of the top panel of the device in FIG. 1, showing detail of the labeling on the removable storage device inserted into it.

FIG. 4 is a ¾ view of the removable storage device with attached labeling seen in FIG. 2 and FIG. 3.

FIG. 5 is a top view of the device in FIG. 4, showing detail of the attached labeling which corresponds to the user controls visible in FIG. 1 and FIG. 3.

FIG. 6 is a ¾ view of a preferred embodiment, a portable video game system.

FIG. 7 is a view of the rear panel of the device in FIG. 6.

FIG. 8 is a view of the top panel of the device in FIG. 6, showing detail of the labeling on the removable storage device inserted into it.

FIG. 9 is a ¾ view of a preferred embodiment, an audio processor and/or synthesizer in a form factor popularly known as a “rack effect” or “rack synthesizer”.

FIG. 10 is a view of the rear panel of the device in FIG. 9.

FIG. 11 is a flowchart of the invention in use.

### DETAILED DESCRIPTION

### Some Definitions, as Used in this Document

A “computer-controlled device” is any device whose functions are substantially performed and/or controlled by one or more computers (a machine for manipulating data according to a list of instructions known as a program.) Examples of such machines include, but are not limited to: microprocessors; microcontrollers; DSPs; many audio and video processing ICs; and so on. Examples of such devices include televisions, video recorders, and their remote controls; modern microwave ovens, dishwashers, and thermostats; answering machines; modern automobile engines; video games; iPods, digital cameras, and cellular phones; industrial machine control systems; and so on.

A “digital audio processor” or “digital audio processing device”, frequently known as an “effects processor”, is a special case of a computer-controlled device. It takes one or more audio inputs, modifies the audio in some way, and sends it to one or more audio outputs. Examples of such modifications, which may be combined, include delay, waveshaping, equalization, and modulation of these modifications by internally or externally generated waveforms, producing results known commonly as “flanging”, “distortion”, “reverberation”, etc. This modification may be performed directly by a digital processor, or indirectly in part or full by analog circuits controlled by the digital processor.

A “stompbox” is a special case of an audio processor, which is designed to be placed in the audio signal chain between an electric musical instrument, such as a guitar, and an amplification device for such an instrument, such as a guitar amplifier. Its enclosure rests on the floor in typical use, and it generally comprises at least one control which the user can operate with a shod foot without damaging the device—usually a switch that bypasses its processing when turned off.

An “audio synthesizer”, “audio synthesizing device”, or “synthesizer” is another special case of a computer-controlled device. It creates audio (this can include playback on demand of previously stored audio, synthetic generation of audio waveforms, and/or combinations of both) and sends it to one or more audio outputs. This audio is typically generated according to user manipulation of the device's controls, or an input data stream representing manipulation of such controls. This generation may be performed directly by a digital processor, or indirectly in part or full by analog circuits controlled by the digital processor. In practice, the difference between an “audio synthesizer” and an “effects processor” is usually only one of software and intended function, and not of physical configuration or hardware capability.

A “rack effect” or “rack unit” is a computer-controlled audio device designed to be placed in a standard 19″ equipment rack. In the context of this patent, it can refer to either an effects processor or synthesizer.

A “user control” is a knob, button, switch, joystick, touch pad, or any other input device by which the user of a device can affect the current or future operation of the device. Examples include buttons on a microwave oven or answering machine; volume and tuning knobs on a radio receiver; joysticks on a video game controller; and so on. Here, the noun “control” refers to a user control unless otherwise specified.

The term “data” here represents any information in computer-readable form. This includes program code, as well as values read or interpreted by program code or other electronic circuitry. The means by which the values are represented, electric, electronic, or mechanical, is not important.

A “storage medium”, “data storage medium”, or “removable data storage medium” is any device capable of storing computer-readable data within itself. (This need not be the device's sole purpose.) For the purposes of this patent, such media are always removable unless otherwise specified. Examples of such devices include, but are not limited to: flash memory such as USB drives, Secure Digital, and Compact Flash cards; RFID tags; CDs and DVDs; video game cartridges and memory cards; key cards for electronic locks; ID or credit cards with magnetic strips, RFID chips, or the like; modern anti-theft automobile keys; and so on.

A “game cartridge” is a special case of a storage medium. It is a removable solid-state data storage medium comprising program code and/or associated data, and labeled as to its contents, so that when it is inserted into the appropriate game system, the user can play the game partially or completely specified by this data. Game cartridges were commonly used through the mid-1990s by video game systems such as the Sega Genesis, Nintendo NES, and Atari 2600, and are still used today in hand-held game systems such as the Nintendo DS and Game Boy Advance.

The term “labeling” here refers to any means by which textual and/or graphic information can be visually associated with the object labeled, and is not limited to the popular definition of a label as a sticker. For instance, labeling may be molded into or dye-sublimated onto a housing, created by arrangement or illumination of pre-existing graphic elements, and so on.

In order to usefully describe the flowchart of the invention in use, we must first describe physical features of preferred embodiments. These implementation-specific details are illustrative, and as such, assumed to be characteristics of the embodiment described and not limitations of the scope of the invention.

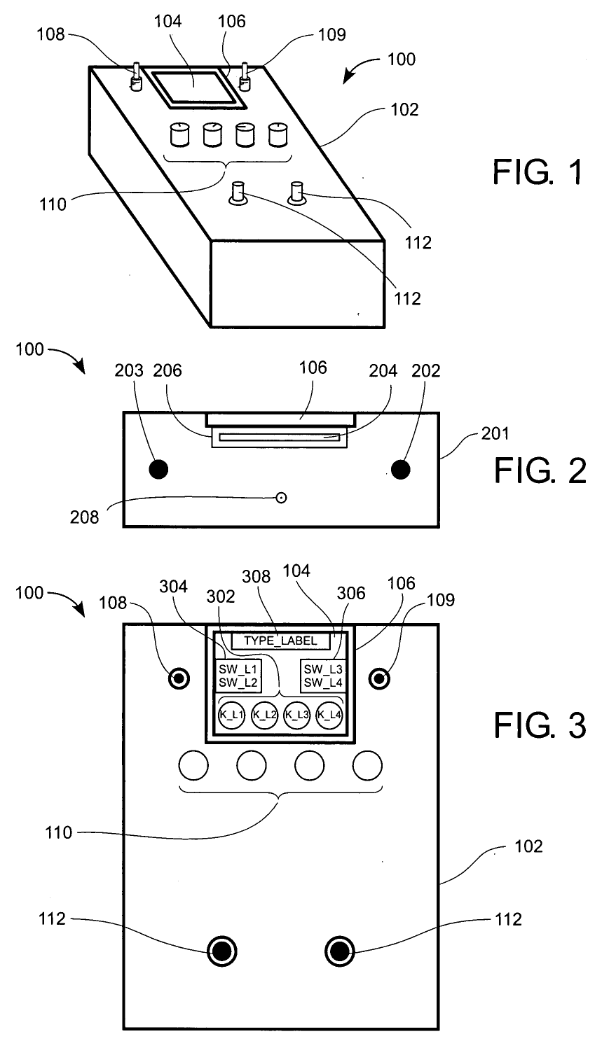

FIG. 1 is a ¾ view of a preferred embodiment of this invention: in this case, an audio processing device known popularly as a “stompbox” 100. FIG. 2 is a rear view of the same device. A storage medium 204 is inserted into a slot 206 in the rear panel 201, and the label 104 on the storage medium is visible through the transparent window 106 in the top panel 102 of the device. An analog audio signal enters the device through the audio input 203 and is processed internally. This processing is affected in whole or in part by data read from the storage medium 204 and the positions of the footswitches 112, control knobs 110, and control switches 108, 109. The user can manipulate these footswitches 112 (designed to be operable by the user's foot when the device is placed on the ground, and one of which is typically used to turn audio processing on and off such that when “off”, audio passes through from input to output without processing), control knobs 110, and control switches 108, 109. The processed signal leaves through the audio output 202. Also on the rear panel is the power connector 208.

FIG. 3 is a top view of the same device in FIG. 1 and FIG. 2, showing details of the labeling 104 on the storage medium 204 (visible through the transparent window 106) and the correspondence of textual and/or graphic elements on the labeling to user controls on the device's top panel 102. Note both the proximity of these elements to the user controls, and the correspondence of the layout to the layout of the user controls: labeling element 304 corresponds to left-hand switch 108, element 306 to right-hand switch 109, and elements 302 to the row of knobs 110. Labeling element 308 indicates the current function of the device generally as defined by the data stored within 105.

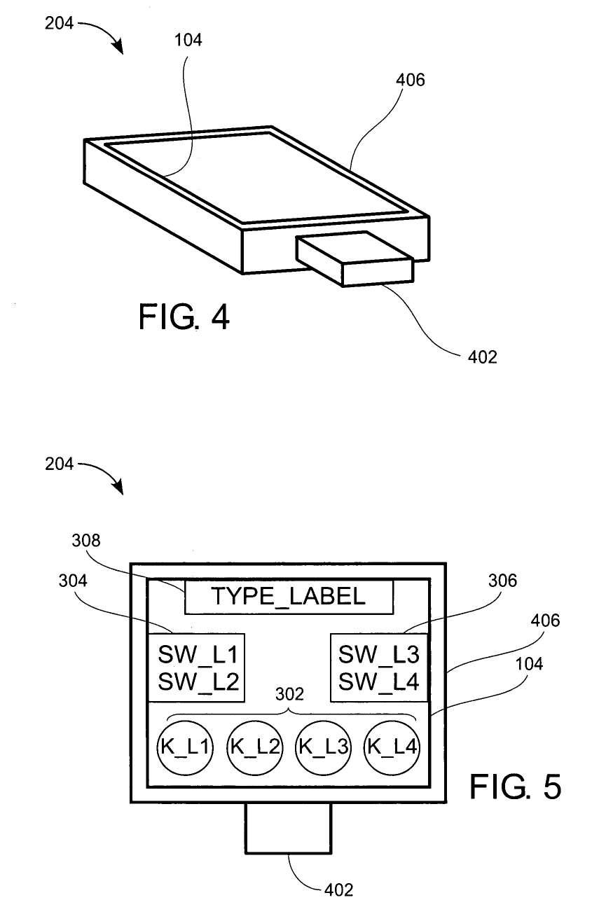

FIG. 4 is a ¾ view of the storage medium 204 with attached labeling 104, as previously seen in FIG. 1, FIG. 2, and FIG. 3. It has a USB connector 402 on its body 406 through which the stompbox 100 can read data from it and write data to it. FIG. 5 is a top view of the same device in FIG. 4, showing the labeling detail previously seen in FIG. 3.

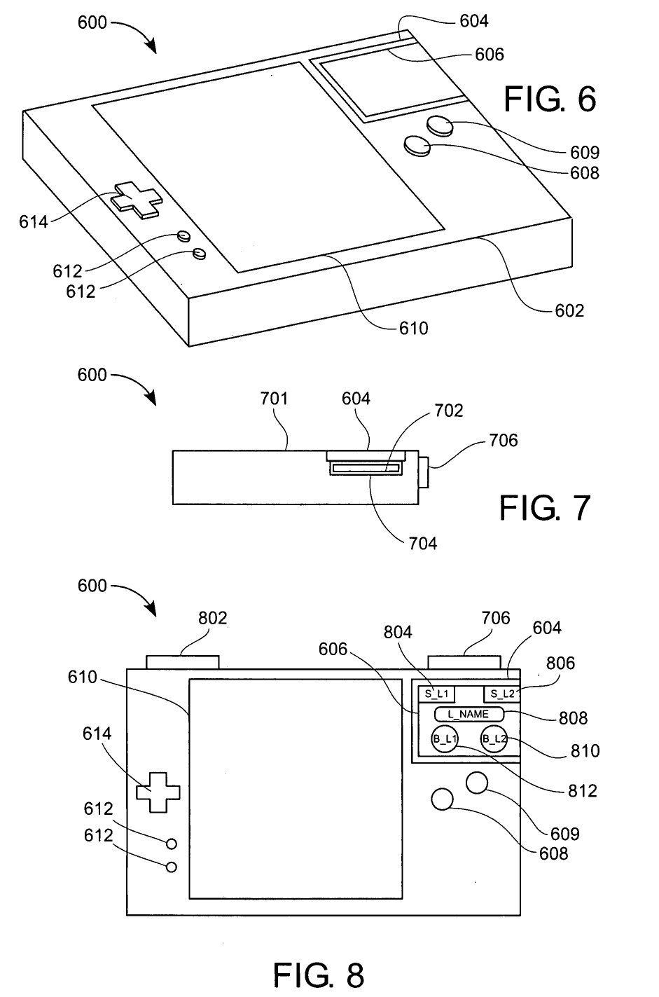

FIG. 6 is a ¾ view of a preferred embodiment of this invention: in this case, a portable video game system 600. FIG. 7 is a right side view of the same device, and FIG. 8 is a top view of the same device. The player controls the game visible on the screen 610 and audible through the speaker (internal, not shown) with the D-pad 614, left buttons 612, right buttons 608, 609, and shoulder buttons 802, 706. A storage medium 702 is inserted into a slot 704 in the side panel 701, and the labeling 606 on the storage medium is visible through the transparent window 604 in the top panel 602 of the device. Elements of the labeling on the storage medium correspond to controls on the device and maintain their layout as far as is practical: element 812 corresponds to button 608, element 810 to button 609, element 806 to shoulder button 706, and element 804 to shoulder button 802. Labeling element 808 shows the game title. Apart from specifics of labeling and dimensions, the storage medium 702 is otherwise similar to that shown in FIG. 4 and FIG. 5

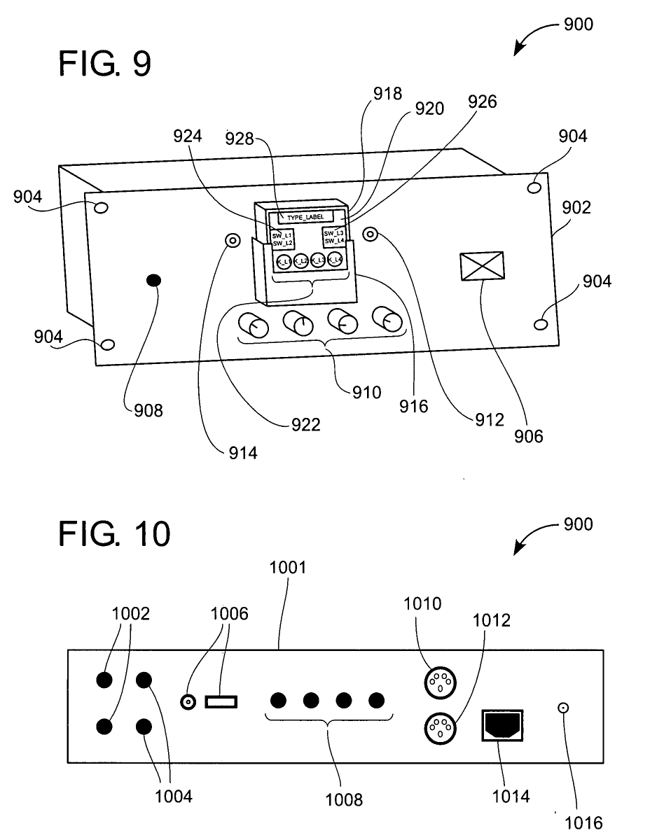

FIG. 9 is a ¾ view of a preferred embodiment 900, an audio processor and/or synthesizer in a form factor popularly known as a “rack effect” or “rack synthesizer”, and known generically as a “rack unit”. (As explained above, the difference is almost always software and primary intended function, and not a matter of physical configuration or hardware capability.) The front panel 902 has a power switch 906 and rack mounting holes 904 which can be affixed to a standard 19″ equipment rack. For convenience when used as a rack effect, an instrument-level analog ¼′ audio input 908 is available on the front panel. Control knobs 910 and switches 912, 914 surround a bracket 916 that holds a storage medium 918 inserted into it. The labeling 920 on the storage medium 918 remains visible due to the construction of the bracket 916. Textual and/or graphic elements of the labeling 920 correspond to some of the available user controls: element 924 to switch 914, element 926 to switch 912, and elements 922 to the row of knobs 910. Element 928 indicates the current function of the device generally as defined partially or completely by the data stored within 918.

FIG. 10 is a view of the rear panel 1001 of the rack unit in FIG. 9. It comprises analog audio inputs 1002, analog audio outputs 1004, digital audio inputs and outputs 1006, external control interface inputs 1008 to which can be connected expression pedals, drum triggers, and the like, MIDI inputs 1010 and MIDI outputs 1012, an Ethernet network port 1014, and a power supply input 1016.

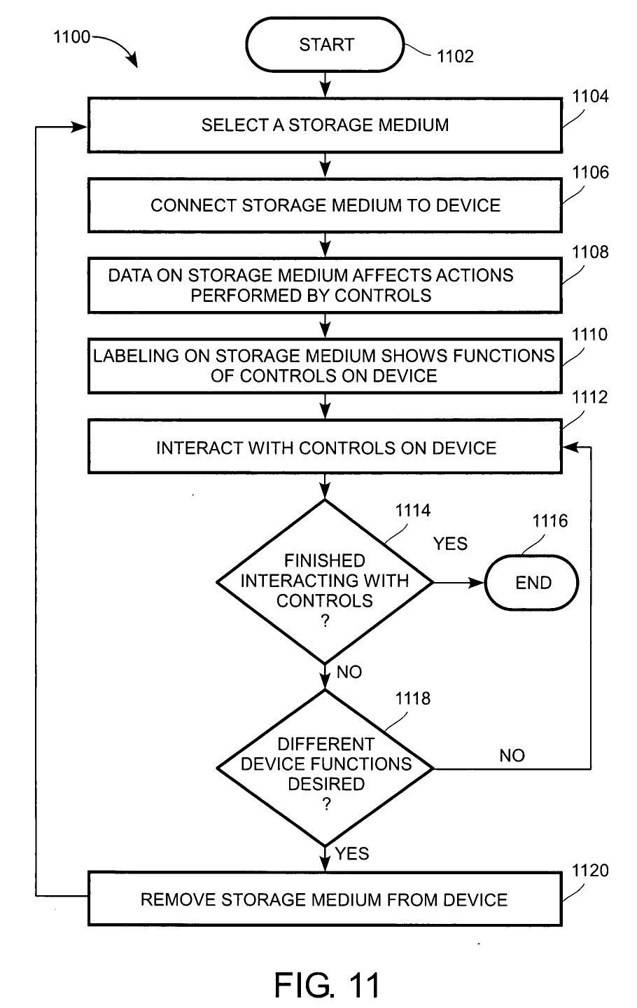

Having described the physical elements of several possible embodiments of the invention, we turn to FIG. 11, a flowchart 1100 of the invention in common use. For clarity, we assume at the start of the flowchart 1102 that the user has already connected the stompbox 100 shown in FIG. 1, FIG. 2, and FIG. 3 to an electric musical instrument via the audio input 203, to an amplifier and speakers via the audio output 202, that power has been connected through the power connector 206, that the unit is powered up, and that plugging or unplugging a storage medium while the unit is powered up does not cause any problems.

In 1104, the user selects a storage medium 204 with attached labeling 104 from those available to him. In 1106, the user inserts the storage medium into the slot 206, connecting it to the stompbox. In 1108, the device reads data from the storage medium. This data comprises parameter data and program code for audio processing algorithms, and it affects the function of the switches 108, 109, 112 and knobs 110.

Having done so, in 1110 the label 104 on the storage medium 204 is visible to the user through a transparent window 106 on the stompbox. The label comprises textual and/or graphical representations 304, 306 of the functions of switches 108, 109 and textual and/or graphical representations 302 of knobs 110, as well as a textual and/or graphical representation 308 of the type of audio processing algorithms the device as a whole currently performs as a partial or complete result of the data read from the storage medium 204.

Now the user can easily manipulate or otherwise interact 1112 with the switches 108, 109, 112 and knobs 110 to affect audio processing in whatever manner he desires, since representations of their function 302, 304, 306, 308 are clearly visible to him while doing so. If the user is finished interacting with the controls 1114, we are done 1116. Otherwise, if the user wishes the stompbox to perform a different set of functions 1118, the user can remove the storage medium from the device 1120, and the process repeats again starting at 1104. If the user is satisfied with the currently available set of functions and audio processing algorithms 1118 but wishes further interaction, we go back to 1112.

These descriptions are illustrative of specific embodiments of the invention, and should not be construed as limiting the scope of the invention. Many other variations are possible, such as: direct or remote controls for audio or audiovisual systems; direct or remote controls for industrial machinery or domestic appliances; direct or remote controllers for toys and videogames; key cards for electronic locks securing any of the previously mentioned variations; cellular phones; and so on. (“Direct or remote controls” include controls on the device itself, as well as separate controls that communicate with the device either directly or wirelessly.)

What is claimed is:

1. A method of labeling user controls of a multi-function computer-controlled device, comprising:
providing a removable data storage medium;
providing labeling attached to said medium;
providing a multi-function computer-controlled device;
providing one or more user controls on said device;
providing one or more user-accessible ports or positions on said device, by which said medium can be attached to said device;
providing data stored within said medium, said data affecting the functions performed by one or more of said user controls of said device;
providing means by which said device can read said data stored within said medium;
providing textual and/or graphical elements on said labeling that describe the function of one or more of said user controls of said device, as enabled or determined partially or completely by said data;
providing physical geometry and dimensions of said device which allow a user of said device to manipulate said controls from a reasonable operating position while simultaneously viewing said labeling;
said method comprising:
connecting said medium to said device;
said device reading said data stored within said medium;
said data affecting the function of one or more of said user controls of said device;
said labeling attached to said medium being visible to said user of said device while said medium is connected to said device and said user is manipulating said user controls;
whereby said user controls of said device are labeled according to their current functions as partially or completely specified by said data contained within said medium, and said labeling is visible to and readable by said user while manipulating said user controls, so that said user can manipulate said user controls of said device from a reasonable operating position without confusion as to the function of said user controls.

2. The method of claim 1, such that the layout of said textual and/or graphical elements corresponds to the layout of said user controls of said device.

3. The method of claim 1 wherein said method controls and configures a device popularly known as a stompbox, said method further comprising:
providing at least one user control which is operable by said user's shod foot without damage to said device or said controls;
providing at least one audio input;
providing at least one audio output.

4. The method of claim 1 wherein said method controls and configures a device popularly known as a rack effect, said method further comprising:
providing means by which the enclosure of said device can be stably affixed to a mounting frame, such as a standard 19″ equipment rack or Eurorack;
providing at least one audio output;
providing at least one audio input.

5. The method of claim 1 wherein said method controls and configures a device popularly known as a rack synthesizer, said method further comprising:
providing means by which the enclosure of said device can be stably affixed to a mounting frame, such as a standard 19″ equipment rack or Eurorack;
providing at least one audio output.

6. The method of claim 1 wherein said method controls and configures a device popularly known as a portable video game system, said method further comprising providing one or more graphic displays visible to said user during normal operation.

7. A multi-function computer-controlled device implementing a method of labeling its user controls, comprising:
said multi-function computer-controlled device;
one or more of said user controls on said device;
one or more user-accessible ports or positions on said device, by which a removable storage medium can be attached to said device;
means of reading data stored within said medium, said data affecting the functions performed by one or more of said user controls of said device;
physical geometry and dimensions of said device which allow a user of said device to manipulate said controls from a reasonable operating position while simultaneously viewing labeling attached to said medium, said labeling comprising textual and/or graphic elements that describe the function of one or more of said user controls, as enabled or determined partially or completely by said data;
and said method comprising:
connecting said medium to said device;
said device reading said data stored within said medium;
said data affecting the function of said user controls of said device;
said labeling attached to said medium being visible to said user of said device while said medium is connected to said device and said user is manipulating said user controls;
textual and/or graphical elements on said labeling attached to said medium that describe the function of one or more of said user controls of said device, as enabled or determined partially or completely by said data;
whereby said user controls of said device are labeled according to their current functions as partially or completely specified by said data contained within said medium, and said labeling is visible to and readable by said user while manipulating said user controls, so that said user can manipulate said user controls of said device from a reasonable operating position without confusion as to the function of said user controls.

8. A removable storage medium implementing a method of labeling user controls on a multi-function computer-controlled device, comprising:
said removable storage medium;
data stored within said medium, said data affecting the functions performed by one or more of said user controls of said computer-controlled device;
labeling attached to said medium, comprising textual and/or graphical elements that describe the function of one or more of said user controls of said device, as enabled or determined partially or completely by said data;
and said method comprising;
connecting said medium to said device;
said device reading said data stored within said medium;
said data affecting the function of said user controls of said device;
said labeling attached to said medium being visible to a user of said device while said medium is connected to said device and said user is manipulating said user controls;
whereby said user controls of said device are labeled according to their current functions as partially or completely specified by said data contained within said medium, and said labeling is visible to and readable by said user while manipulating said user controls, so that said user can manipulate said user controls of said device from a reasonable operating position without confusion as to the function of said user controls.

9. The medium of claim 8, such that the layout of said textual and/or graphical elements corresponds to the layout of said user controls of said device.

10. The device of claim 7 wherein said device is popularly known as a stompbox, said device further comprising:
at least one user control which is operable by said user's shod foot without damage to said device or said controls;
at least one audio input;
at least one audio output.

11. The device of claim 7 wherein said device is popularly known as a rack effect, said device further comprising:
means by which the enclosure of said device can be stably affixed to a mounting frame, such as a standard 19″ equipment rack or Eurorack;
at least one audio output;
at least one audio input.

12. The device of claim 7 wherein said device is popularly known as a rack synthesizer, said device further comprising:
means by which the enclosure of said device can be stably affixed to a mounting frame, such as a standard 19″ equipment rack or Eurorack;
at least one audio output.

13. The device of claim 7 wherein said device is popularly known as a portable video game system, said device further comprising one or more graphic displays visible to said user during normal operation.

14. The device of claim 7, such that the layout of said textual and/or graphical elements corresponds to the layout of said user controls of said device.

15. The medium of claim 8 wherein said device is popularly known as a stompbox, said device further comprising:
at least one user control which is operable by said user's shod foot without damage to said device or said controls;
at least one audio input;
at least one audio output.

16. The medium of claim 8 wherein said device is popularly known as a rack effect, said device further comprising:
means by which the enclosure of said device can be stably affixed to a mounting frame, such as a standard 19″ equipment rack or Eurorack;
at least one audio output;
at least one audio input.

17. The medium of claim 8 wherein said device is popularly known as a rack synthesizer, said device further comprising:
means by which the enclosure of said device can be stably affixed to a mounting frame, such as a standard 19″ equipment rack or Eurorack;
at least one audio output.

18. The medium of claim 8 wherein said device is popularly known as a portable video game system, said device further comprising one or more graphic displays visible to said user during normal operation.
